(19) United States
(12) Patent Application Publication
(10) Pub. No.: US 2026/0172873 A1
(43) Pub. Date: Jun. 18, 2026

(54) METHOD AND APPARATUS FOR SIGNAL MEASUREMENT AND REPORTING IN WIRELESS COMMUNICATION SYSTEM

(71) Applicant: Samsung Electronics Co., Ltd., Gyeonggi-do (KR)

(72) Inventors: Jeehwan NOH, Gyeonggi-do (KR); Hyungwoo KU, Gyeonggi-do (KR)

(21) Appl. No.: 19/404,595

(22) Filed: Dec. 1, 2025

(30) Foreign Application Priority Data
Dec. 17, 2024 (KR) 10-2024-0188699

(51) Int. Cl. H04W 24/10; H04B 7/06

(52) U.S. Cl. CPC H04W 24/10; H04B 7/06952

(57) ABSTRACT

The present disclosure relates to a 5G communication system or a 6G communication system for supporting higher data rates beyond a 4G communication system such as long term evolution. A method performed by a user equipment includes receiving, from a base station, a radio resource control message including configuration information for measuring and reporting of synchronization signal blocks (SSBs), measuring multiple SSBs for multiple component carriers, based on the configuration information, and transmitting, to the base station, a report on a result of the measurement, based on the configuration information.

### CROSS-REFERENCE TO RELATED APPLICATION(S)

This application is based on and claims priority under 35 U.S.C. § 119 to Korean Patent Application No. 10-2024-0188699, filed on Dec. 17, 2024, in the Korean Intellectual Property Office, the disclosure of which is incorporated herein by reference in its entirety.

### BACKGROUND

### 1. Field

The disclosure relates generally to a method and device in a wireless communication system, and more particularly, to a method and apparatus including configuration information and corresponding operations for measuring a signal and reporting a measurement result in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to provide a method and an apparatus for measuring an RF signal and reporting a measurement result in advanced wireless communication systems.

Another aspect of the disclosure is to provide a method and apparatus to measure signals transmitted via different beams and report a measurement result when a base station may transmit signals by using different beams in the same time resource.

Another aspect of the disclosure is to measure signals transmitted via different component carriers (CCs) and report a measurement result when a base station may transmit signals by using different CCs in the same time resource.

In accordance with an aspect of the disclosure, a method performed by a user equipment in a wireless communication system according to embodiments of the disclosure includes receiving, from a base station, a radio resource control (RRC) message including configuration information for measurement and reporting of synchronization signal blocks (SSBs), measuring multiple SSBs for multiple component carriers, based on the configuration information, and transmitting, to the base station, a report on a result of the measurement, based on the configuration information.

In accordance with an aspect of the disclosure, a user equipment in a wireless communication system according to embodiments of the disclosure includes a transceiver and a controller connected to the transceiver, and the controller may be configured to receive, from a base station, an RRC message including configuration information for measurement and reporting of SSBs, measure multiple SSBs for multiple component carriers, based on the configuration information, and transmit, to the base station, a report on a result of the measurement, based on the configuration information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment;

FIG. 2 illustrates a structure of a UE according to an embodiment;

FIG. 3 illustrates a structure of a network entity (or base station) according to an embodiment;

FIG. 4 illustrates beam sweeping methods of a base station according to an embodiment;

FIG. 5 illustrates beam sweeping methods for SSB transmission by a base station according to an embodiment;

FIG. 6 illustrates configuration information related to SSB measurement by a user equipment according to an embodiment;

FIG. 7 illustrates configuration information related to SSB measurement by a user equipment according to an embodiment;

FIG. 8 illustrates configuration information related to SSB measurement by a user equipment according to an embodiment;

FIG. 9 illustrates configuration information related to SSB measurement by a user equipment according to an embodiment;

FIG. 10 illustrates configuration information related to SSB measurement reporting by a user equipment according to an embodiment;

FIG. 11 illustrates information on fields related to SSB measurement reporting by a user equipment according to an embodiment;

FIG. 12 illustrates information for mapping SSB and random access channel (RACH) occasion (RO) by a user equipment according to an embodiment;

FIG. 13 illustrates a mapping operation of SSB and corresponding RO by a user equipment according to an embodiment;

FIG. 14 illustrates transmission and reception operations of a user equipment and a base station according to an embodiment; and

FIG. 15 illustrates transmission and reception operations of a user equipment and a base station according to an embodiment.

### DETAILED DESCRIPTION

Embodiments of the disclosure will be described in detail with reference to the accompanying drawings.

Descriptions of techniques that are well known in the art and not directly related to the disclosure are omitted for the sake of clarity and conciseness.

For the same reasons, some elements are exaggerated, omitted, or schematically illustrated in the attached drawings. The size of each element may not substantially reflect its actual size. In each drawing, the same or corresponding element is denoted by the same reference numeral.

The terms used in the disclosure are used merely to describe particular embodiments, and may not be intended to limit the scope of other embodiments, singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Embodiments of the disclosure will be described based on an approach of hardware and may include a technology that uses both hardware and software.

Furthermore, embodiments of the disclosure will be described using terms employed in some communication standards (e.g., the 3rd generation partnership project (3GPP)), but they are for illustrative purposes only and may also be easily applied to other communication systems through modifications.

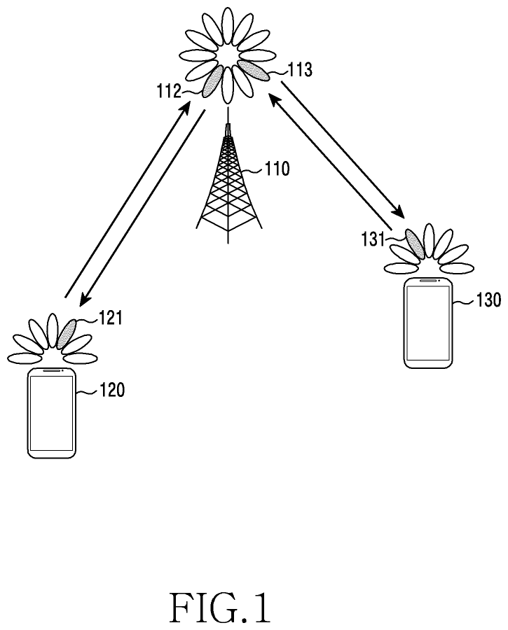

FIG. 1 illustrates a wireless communication system according to an embodiment.

Referring to FIG. 1, a base station 110, a first UE 120, and/or a second UE 130 are illustrated as some of nodes using a radio channel in the wireless communication system. FIG. 1 illustrates only one base station, but additional base stations identical or similar to the base station 110 may be further included in the wireless communication system of FIG. 1.

The base station 110 may be a network infrastructure that provides radio access to the UEs 120 and 130. The base station 110 has coverage defined as a certain geographical area, based on a distance over which a signal can be transmitted. In addition to the term base station, the base station 110 may be referred to as an access point (AP), an evolved Node B (eNB), a next generation Node B (gNB), a 5th generation node (5G node), a wireless point, a transmission/reception point (TRP), or other terms having technical meanings equivalent thereto.

Each of the first UE 120 and the second UE 130 is a device used by a user, and may perform communication with the base station 110 via a radio channel. At least one of the UE 120 and the UE 130 may be operated without the user's involvement. For example, at least one of the first UE 120 and the second UE 130 may be a device which performs machine type communication (MTC), and may not be carried by the user. In addition to the term terminal, each of the first UE 120 and the second UE 130 may be referred to as a user equipment (UE), a mobile station, a subscriber station, a customer-premises equipment (CPE), a remote terminal, a wireless terminal, an electronic device, a user device, or other terms having technical meanings equivalent thereto.

The base station 110, the first UE 120, and the second UE 130 may transmit and/or receive wireless signals in mmWave bands (e.g., 28 GHz, 30 GHz, 38 GHz, and 60 GHz). In this case, to improve channel gain, the base station 110, the first UE 120, and the second UE 130 may perform beamforming.

The beamforming may include transmission beamforming and/or reception beamforming. That is, the base station 110, the first UE 120, and the second UE 130 may assign directivity to a transmission signal or a reception signal by the base station 110 and/or the UEs 120 and 130 selecting serving beams 112, 113, 121, and 131 through a beam search or beam management procedure. After the serving beams 112, 113, 121, and 131 are selected, subsequent communication may be performed through a resource having a quasi co-located (QCL) relationship with a resource through which the serving beams 112, 113, 121, and 131 have been transmitted.

Each of the base station 110, the first UE 120, and the second UE 130 of the disclosure may be a transmitting apparatus, a transmitting node, a receiving node, a receiving apparatus, and/or a receiving node. The base station 110 may transmit an RF signal to the first UE 120 and may receive an RF signal from the first UE 120. The first UE 120 may transmit an RF signal to the base station 110 or the second UE 130 and may receive an RF signal from the base station 110 or the second UE 130.

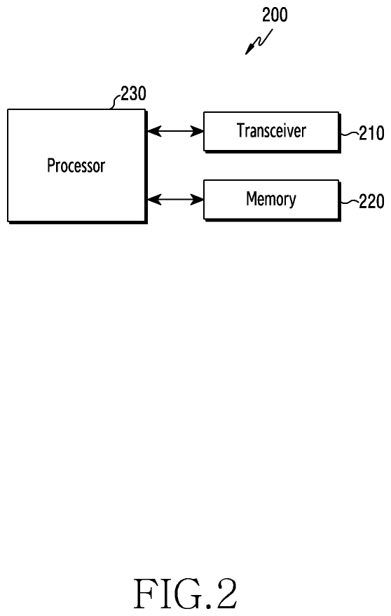

FIG. 2 illustrates a structure of a UE according to an embodiment.

Referring to FIG. 2, the UE 200 may include a transceiver 210, a memory 220, and/or a processor 230, but this is merely an example and the UE 200 may further additional components.

Each of the transceiver 210, the memory 220, and the processor 230 may be implemented as a separate chip. However, this is merely an example, and the transceiver 210, the memory 220, and/or the processor 230 may be implemented as a single chip.

The transceiver 210 may include at least one transmitter and/or at least one receiver. The transceiver 210 may include an RF transmitter for amplifying and up-converting the frequency of a transmitted signal. The transceiver 210 may include an RF receiver for down-converting and low-noise amplifying the frequency of a received signal.

The components of the transceiver 210 set forth herein are merely an example, and the components of the transceiver 210 are not limited to the RF transmitter and the RF receiver. The transceiver 210 may further include a coupler for ensuring isolation between the RF transmitter and the RF receiver.

The transceiver 210 may transmit or receive a signal to or from the processor 230. The transceiver 210 may transmit or deliver an RF signal, received via a radio channel, to the processor 230. The transceiver 210 may receive an RF signal from the processor 230 or the processor 230 may deliver an RF signal to the transceiver 210.

The transceiver 210 may be referred to as a UE transmitter or a UE receiver.

The transceiver 210 may transmit a signal to a base station 110 or a network entity (e.g., access and mobility management function (AMF) entity) or receive a signal from the base station or the network entity. The transmitted or received signal may include a control signal or data.

The memory 220 may store programs and data necessary for the operations of the UE 200. example, the memory 220 may be a non-transitory memory, and programs stored in the non-transitory memory may be organically coupled to hardware components (e.g., the processor 230 or the transceiver 210) of the UE 200. The memory 220 may store control information or data including a signal acquired by the UE 200. The memory 220 may include a read-only memory (ROM), a random access memory (RAM), a hard disk, a compact disc (CD)-ROM, a digital versatile disc (DVD), or storage media.

The processor 230 may include one processor or multiple processors. The processor 230 may include a communication processor. The processor 230 may include a communication processor and/or an application processor.

The processor 230 may control a series of processes performed by the UE 200. The transceiver 210 may receive a data signal including control information transmitted by the base station or the network entity. The processor 230 may process the received control signal and data signal.

The term processor herein may be replaced with various terms referring to components for executing or performing the operations of the UE 200. The processor may be replaced with the term controller or computing circuit.

The UE 200 may correspond to the first UE 120 and/or the second UE 130 in FIG. 1.

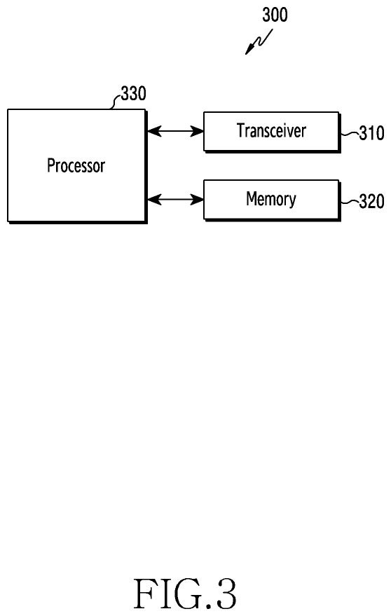

FIG. 3 illustrates a structure of a network entity (or base station) according to an embodiment.

Referring to FIG. 3, the network entity 300 may include a transceiver 310, a memory 320, and/or a processor 330. Although the network entity 300 is described herein as including the transceiver 310, the memory 320, and/or the processor 330, this is merely an example. The network entity 300 may further include components other than the transceiver 310, the memory 320, and the processor 330. The network entity 300 may represent a base station or other network functions included in a core network.

Each of the transceiver 310, the memory 320, and the processor 330 may be implemented as a separate chip. However, this is merely an example, and the transceiver 310, the memory 320, and/or the processor 330 may be implemented as a single chip.

The transceiver 310 may include at least one transmitter and/or at least one receiver. The transceiver 310 may include an RF transmitter for amplifying and up-converting the frequency of a transmitted signal. The transceiver 310 may include an RF receiver for down-converting and low-noise amplifying the frequency of a received signal.

The components of the transceiver 310 set forth herein are merely an example, and the components of the transceiver 310 are not limited to the RF transmitter and the RF receiver. The transceiver 310 may further include a coupler for ensuring isolation between the RF transmitter and the RF receiver.

The transceiver 310 may transmit or receive a signal to or from the processor 330. The transceiver 310 may transmit or deliver an RF signal, received via a radio channel, to the processor 330. The transceiver 310 may receive an RF signal from the processor 230 or the processor 230 may deliver an RF signal to the transceiver 210.

The transceiver 310 may be referred to as a network entity transmitter or network entity receiver.

The transceiver 310 may transmit a signal to the UE 200 or other network entities or receive a signal from the UE 200 or other network entities. The transmitted or received signal may include a control signal or data.

The memory 320 may store programs and data necessary for the operations of the network entity 300. The memory 320 may be a non-transitory memory, and programs stored in the non-transitory memory may be organically coupled to hardware components (e.g., the processor 330 or the transceiver 310) of the network entity 300. The memory 320 may store control information or data including a signal acquired by the network entity 300. The memory 320 may include a ROM, a RAM, a hard disk, a CD-ROM, a DVD, or storage media.

The processor 330 may include one processor or multiple processors. The processor 330 may include a communication processor. The processor 330 may include a communication processor and/or an application processor.

The processor 330 may control a series of processes performed by the network entity 300. The transceiver 310 may receive a data signal including control information transmitted by the UE or the network entity. The processor 330 may process the received control signal and data signal.

The term processor of the disclosure may be replaced with various terms referring to components for executing or performing the operations of the network entity 300. The processor may be replaced with the term controller or computing circuit.

The network entity 300 herein may correspond to the base station 110 in FIG. 1.

The device described in FIG. 2 or FIG. 3 may correspond to a device of a transmitting node or receiving node. The UE or network entity may be a transmitting node on the transmitting side and may be a receiving node on the receiving side.

Herein, the transmitting node and the receiving node nay refer to the UEs or the base station described above in FIG. 1 to FIG. 3.

The UEs or the base station described in FIG. 1 to FIG. 3 may perform operations of transmitting/receiving configuration information related to measurement of a signal transmitted by the base station and reporting of the measurement result, and operations related to measurement and reporting based on the configuration information.

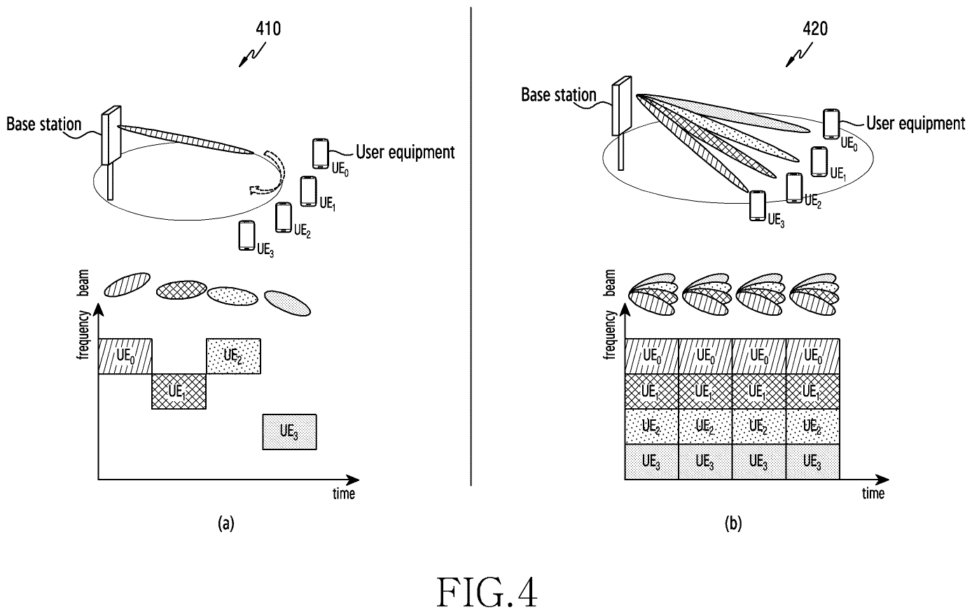

FIG. 4 illustrates beam sweeping methods of a base station according to an embodiment.

Referring to FIG. 4, a first system 410 and a second system 420 for a base station (or an antenna panel capable of transmitting a beam included in the base station) to transmit beams to UEs (UE_0, UE_1, UE_2, and UE_3) are illustrated.

In the first system 410, a single antenna panel cannot simultaneously transmit beams with different directions. For example, a single antenna panel may transmit a first beam to UE_0 by using a first time resource, a second beam to UE_1 by using a second time resource, a third beam to UE_2 by using a third time resource, and a fourth beam to UE_3 by using a fourth time resource. The first to fourth time resources represent different time resources. That is, since the antenna panel cannot transmit multiple beams with different directions by using the same time resource, the antenna panel may only transmit one beam per unit time resource, and a significant amount of time resources are consumed to transmit all of the multiple beams. The first system 410 may represent a beamforming system in which a phase shifter is connected to an antenna element to form the same beams on a single time resource.

In the second system 420, a single antenna panel may simultaneously transmit beams with different directions. For example, a single antenna panel may transmit a first beam to UE_0, a second beam to UE_1, a third beam to UE_2, and a fourth beam to UE_3 by using a first time resource. The frequency bands in which the first to fourth beams are transmitted may be assigned differently. In the second system 420, since the antenna panel may transmit multiple beams with different directions by using the same time resource, the amount of time resource required to transmit all beams may be less than that of the first system 410. The second system 420 may represent a beamforming system capable of transmitting different beams for each frequency band (or component carrier) on a single time resource by applying time delay for each antenna element.

The first system 410 and the second system 420 may include an analog beamforming system.

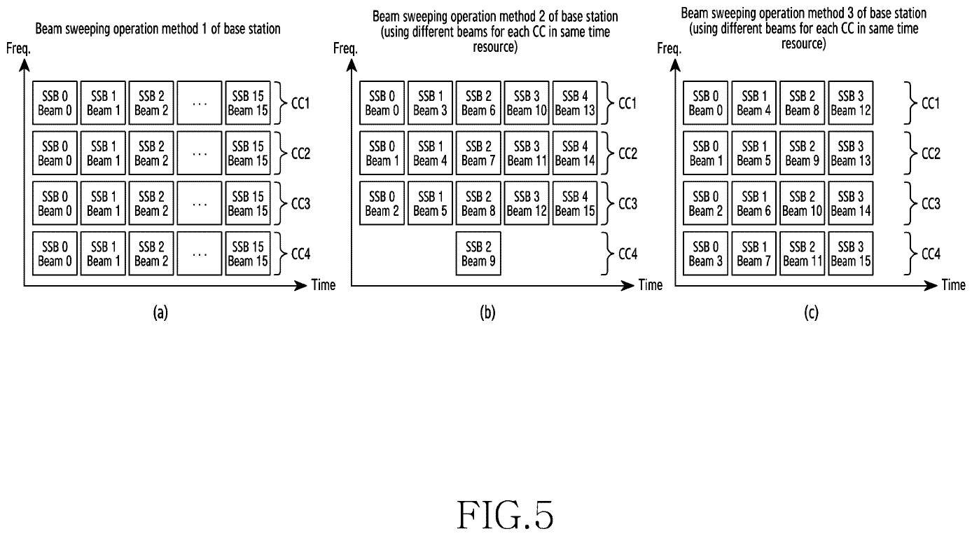

FIG. 5 illustrate a beam sweeping method for SSB transmission by a base station according to an embodiment.

Referring to graph (a) in FIG. 5, a beam sweeping method (first method) for SSB transmission by a base station in the first system 410 of FIG. 4 is illustrated. In the first method, the base station may transmit SSB 0 by using the same beam (e.g., beam 0) for each CC representing a frequency band within the same time resource. Specifically, the base station may transmit SSB 0 by using beam 0 in the first CC (CC 1) through the fourth CC (CC 4) by using the first time resource, and transmit SSB 1 by using beam 1 in the CC 1 through CC 4 by using the second time resource. For 16 beams with different directions (beam 0 through beam 15), the base station may use 16 unit time resources to transmit SSB by using beam 0 through beam 15 for each CC. In this case, the unit time resource may represent the time resource required to transmit SSB with one beam.

Referring to graph (b), a beam sweeping method (second method) for SSB transmission by a base station in the second system 420 of FIG. 4 is illustrated. In the second method, the base station may transmit SSB 0 by using different beams for each CC representing a frequency band within the same time resource. Specifically, the base station may transmit SSB 0 by using beam 0, beam 1, beam 2, and beam 3 in the CC 1 through CC 3 by using the first time resource. The base station may transmit SSB 0 by using beam 0 in the first CC of the first time resource, SSB 0 by using beam 1 in the second CC, and SSB 0 by using beam 2 in the third CC. Similarly, the base station may transmit SSB 1 by using beams 3, 4, and 5 in the CC 1 through CC 3 by using the second time resource. The base station may transmit SSB 2 by using beams 6, 7, 8, and 9 in the CC 1 through CC 4 by using the third time resource. According to the second method, five unit time resources may be required for the base station to transmit SSB 0 through SSB 4 by using beams 0 through 15 in CC 1 through CC 4. The unit time resource may represent the time resource required to transmit SSB with one beam.

Referring to graph (c), a beam sweeping method (third method) for SSB transmission by a base station in the second system 420 of FIG. 4 is illustrated. In the third method, the base station may transmit SSB 0 by using different beams for each CC representing a frequency band within the same time resource. Specifically, the base station may transmit SSB 0 by using beam 0, beam 1, beam 2, and beam 3 in the CC 1 through CC 4 by using the first time resource. The base station may transmit SSB 0 by using beam 0 in the first CC of the first time resource, SSB 0 by using beam 1 in the second CC, and SSB0 by using beam 2 in the third CC, and SSB 0 by using beam 3 in the fourth CC. Similarly, the base station may transmit SSB 1 by using beams 4, 5, 6, and 7 in the CC 1 through CC 4 by using the second time resource. The base station may transmit SSB 2 by using beams 8, 9, 10, and 11 in the CC 1 through CC 4 by using the third time resource. According to the third method, four unit time resources may be required for the base station to transmit SSB 0 through SSB 3 by using beams 0 through 15 in CC 1 through CC 4. The unit time resource may represent the time resource required to transmit SSB with one beam.

The base station may perform beam sweeping to transmit SSB in a manner different from that of graphs (a), (b), and (c). The number of beams operated by the base station, the number of SSBs transmitted by the base station, the number of component carriers, and the like may be configured differently from those illustrated in FIG. 5.

The UE may measure the SSB transmitted by the base station and report the measurement result to the base station. With respect to the measurement and reporting operations of the UE, the base station may transmit RRC configuration information to the UE, and the UE may measure the SSB based on the received configuration information and report the measurement result to the base station.

In graph (a), since the base station transmits the SSB by using all the beams in one CC, the UE may be configured to measure and report the SSB received in the corresponding CC.

However, in graphs (b) and (c), since the base station transmits SSBs by using different beams for multiple CCs within the same time resource, the UE needs to be configured to measure SSBs transmitted via multiple CCs and report the measurement result to the base station. That is, the UE may be configured to measure and report SSBs received via different CCs.

The UE may measure the SSBs received with different beams for multiple CCs within the same time resource and report the measurement result to the base station.

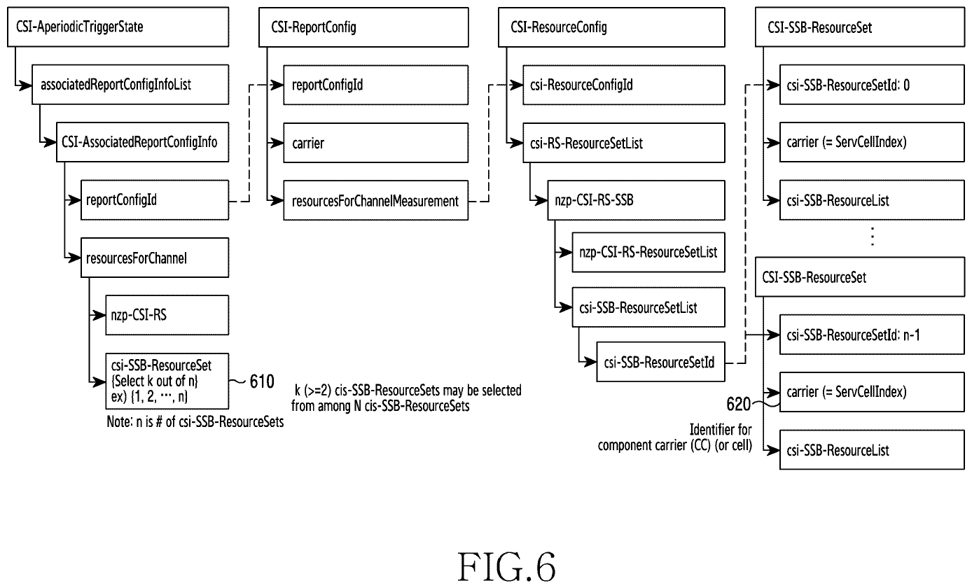

FIG. 6 illustrates configuration information related to SSB measurement by a user equipment according to an embodiment.

Referring to FIG. 6, the RRC configuration information includes information (e.g., CSI-SSB-ResourceSet) on a resource set related to SSB measurement. The CSI-SSB-ResouceSet is identified by an identifier such as csi-SSB-ResouceSetID and may include an identifier (e.g., carrier (ServCellIndex)) 620 indicating a CC for the resource set and/or list information (e.g., csi-SSB resourceList) including values corresponding to the resources included in the resource set. The identifier 620 indicating a CC may indicate a CC (e.g., first CC) corresponding to resources included in the CSI-SSB-ResourceSet for SSB measurement.

The RRC configuration information may further include information (e.g., resourcesForChannel) for indicating at least two resource sets selected from among multiple resource sets (e.g., CSI-SSB-ResourceSets) for SSB measurement. The resourcesForChannel may include identifiers (or entry numbers) 610 for indicating at least two of the multiple resource sets. The resourcesForChannel may include at least two entry numbers of csi-SSB-ResourceSetList within CSI-ResourceConfig indicated by resourcesForChannelMeasurement within CSI-ReportConfig indicated by reportConfigID. Therefore, information on multiple resource sets may be identified by csi-SSB-ResourceSetId within csi-SSB-ResourceSetList indicated by at least two entry numbers. That is, the UE may identify which of the multiple resource sets are to be measured in relation to SSB measurement.

Based on the configuration information (e.g., resourcesForChannel and carrier) illustrated in FIG. 6, the UE may identify at least two resource sets (e.g., resource sets with csi-SSB-ResourceSetIDs of 0 and 1) for SSB measurement. The UE may identify each of the CCs corresponding to the identified resource sets and perform SSB measurement even when the CCs for each resource set are different. The UE may measure the SSB received from the first CC and the SSB received from the second CC.

The names of the parameters shown in FIG. 6 may be applied differently, and parameter identity or similarity may be determined based on the content of the information contained in the parameters and their purpose.

The inclusion or connection relationship between the parameters shown in FIG. 6 is not limited to the content shown in FIG. 6, and embodiments in which the parameters have inclusion or connection relationships different from those in FIG. 6 are not excluded.

In FIG. 6, CSI-AperiodicTriggerState may include configuration information related to SSB measurement and reporting based on an aperiodic trigger. Specifically, the CSI-AperiodicTriggerState may include CSI-AssociatedReportConfigInfo, and the CSI-AperiodicTriggerState may include resourcesForChannel.

The reportConfigId may indicate the identifier of configuration information (e.g., CSI-ReportConfig) on reporting of measurement result of the UE. The carrier may indicate the cell or CC for the CSI-ResourceConfig related (or linked) to the CSI-ReportConfig. The resourcesForChannelMeasurement may include identifiers (csi-ResourceConfigId) corresponding to resource configurations (CSI-ResourceConfig) related to the cell or CC indicated by the carrier, thereby allowing the UE to identify the resource configurations (CSI-ResourceConfig) related to the corresponding cell or CC.

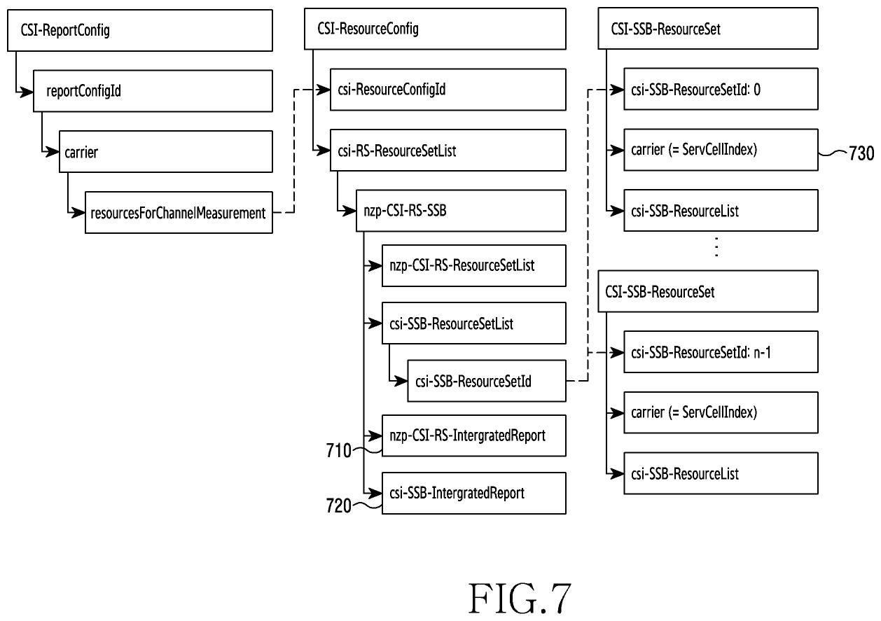

FIG. 7 illustrates configuration information related to SSB measurement by a user equipment according to an embodiment.

Referring to FIG. 7, the RRC configuration information includes information (e.g., CSI-SSB-ResourceSet) on a resource set related to SSB measurement. The CSI-SSB-ResouceSet is identified by an identifier such as csi-SSB-ResouceSetID and may include an identifier (e.g., carrier (ServCellIndex)) 730 indicating a CC for the resource set and/or list information (e.g., csi-SSB resourceList) including identifiers corresponding to the resources included in the resource set. The identifier 730 indicating a CC may indicate a cell or a first CC corresponding to resources included in the CSI-SSB-ResourceSet for SSB measurement.

The RRC configuration information may include list information (e.g., non-zero power channel state information reference signal (nzp-CSI-RS)-ResourceSetList or csi-SSB-ResourceSetList) including multiple resource sets (e.g., CSI-SSB-ResourceSets) for SSB measurement and their corresponding identifiers. The RRC configuration information may include fields (e.g., nzp-CSI-RS-IngratedReport or csi-SSB-IngratedReport) 710 and 720 that indicate the UE to measure all identifiers included in the list information and corresponding resource sets and report the results in a single CSI report. Specifically, the nzp-CSI-RS-IngratedReport 710 may be a field that indicates the UE to perform measurements on all resource sets indicated by the nzp-CSI-RS-ResourceSetList and report the results in a single CSI report. The csi-SSB-IngratedReport 720 may be a field that indicates the UE to perform measurements on all resource sets indicated by the csi-SSB-ResourceSetList and report the measurements in a single CSI report.

Based on the configuration information illustrated in FIG. 7, the UE may identify information (e.g., ResourceSet) on multiple resource sets indicated by the ResourceSetList, measure SSBs for all resource sets indicated in the list, and report the measurement result to the base station in a single CSI report. Since the information (e.g., ResourceSet) on a resource set includes the identifiers of the CCs corresponding to the resources for SSB measurement, the UE may perform measurements on resource sets corresponding to different CCs.

The names of the parameters shown in FIG. 7 may be applied differently, and parameter identity or similarity may be determined based on the content of the information contained in the parameters and their purpose.

The inclusion or connection relationship between the parameters shown in FIG. 7 is not limited to the content shown in FIG. 7, and embodiments in which the parameters have inclusion or connection relationships different from those in FIG. 7 are not excluded.

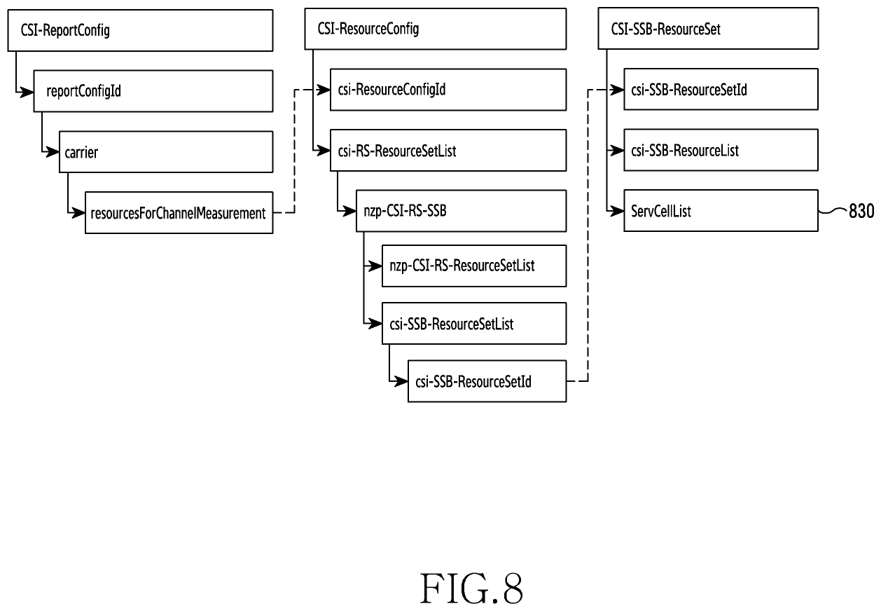

FIG. 8 illustrates configuration information related to SSB measurement by a user equipment according to an embodiment.

Referring to FIG. 8, the RRC configuration information includes information (e.g., CSI-SSB-ResourceSet) on a resource set related to SSB measurement. The CSI-SSB-ResouceSet is identified by an identifier such as csi-SSB-ResouceSetID and may include list information (e.g., csi-SSB-ResourceList) for indicating the resources in the resource set and/or list information (e.g., ServCellList) 830 for indicating the cells or CCs for the resources. Specifically, the resources indicated in csi-SSB-ResourceList and the CCs indicated in ServCellList 830 may correspond to each other. The resource indicated in the first position of csi-SSB-ResourceList may correspond to the CC indicated in the first position of ServCellList 830.

Based on the configuration information illustrated in FIG. 8, the UE may identify information (e.g., ResourceSet) on a resource set and the CCs for each resource included in the resource set. The UE may identify that the first resource in the first resource set corresponds to the first CC, and that the second resource in the first resource set corresponds to the second CC. Therefore, the UE may perform SSB measurements on resources corresponding to different CCs.

The names of the parameters shown in FIG. 8 may be applied differently, and parameter identity or similarity may be determined based on the content of the information contained in the parameters and their purpose.

The inclusion or connection relationship between the parameters shown in FIG. 8 is not limited to the content shown in FIG. 8, and embodiments in which the parameters have inclusion or connection relationships different from those in FIG. 8 are not excluded.

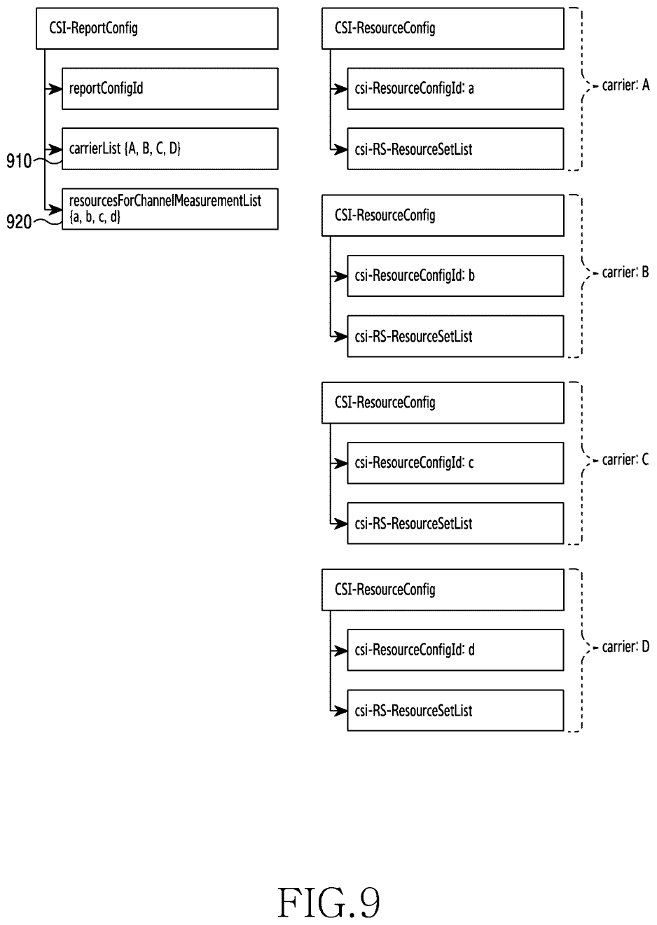

FIG. 9 illustrates configuration information related to SSB measurement by a user equipment according to an embodiment.

Referring to FIG. 9, the RRC configuration information may include configuration information (e.g., CSI-ReportConfig) on measurement result reporting. The CSI-ReportConfig may include list information (e.g., carrierList) (A, B, C, D) 910 including identifiers for indicating CCs related to SSB measurement, and list information (e.g., resourceForChannelMeasurementList) 920 including identifiers for indicating resource configuration information (e.g., CSI-ResourceConfig) for SSB measurement. The CSI-ResourceConfig may include list information (csi-RS-ResourceSetList) including identifiers for indicating CSI-ResourceConfig and/or identifiers for indicating a resource set for SSB measurement.

Based on the configuration information illustrated in FIG. 9, the UE may identify the CSI-ReportConfig. In addition, based on the carrierList 910 and the resourceForChannelMeasurementList 920 included in the CSI-ReportConfig, the UE may identify the CC corresponding to each of the multiple CSI-ResourceConfigs indicated in the resourceForChannelMeasurementList 920. For example, if the identifier included in the resourceForChannelMeasurementList 920 is a, the UE may identify that the CC for the resource sets included in the resource set list (e.g., csi-RS-ResourceSetList) included in the CSI-ResourceConfig (csi-ResourceConfigId: a) with identifier a is A. That is, the resource configuration information indicated by the resourceForChannelMeasurementList 920 and the CC indicated by the carrierList 910 may correspond to each other. The resource configuration information indicated in the first position of the resourceForChannelMeasurementList 920 may be resource configuration information corresponding to the CC indicated in the first position of the carrierList 910.

Therefore, the UE may identify the CC for each of the multiple CSI-ResourceConfigs via the CSI-ReportConfig, and thus may measure SSB for the resource set indicated by the multiple CSI-ResourceConfigs with different CCs.

The names of the parameters shown in FIG. 9 may be applied differently, and parameter identity or similarity may be determined based on the content of the information contained in the parameters and their purpose.

In various embodiments, the inclusion or connection relationship between the parameters shown in FIG. 9 is not limited to the content shown in FIG. 9, and embodiments of the disclosure do not exclude embodiments in which the parameters have inclusion or connection relationships different from those in FIG. 9.

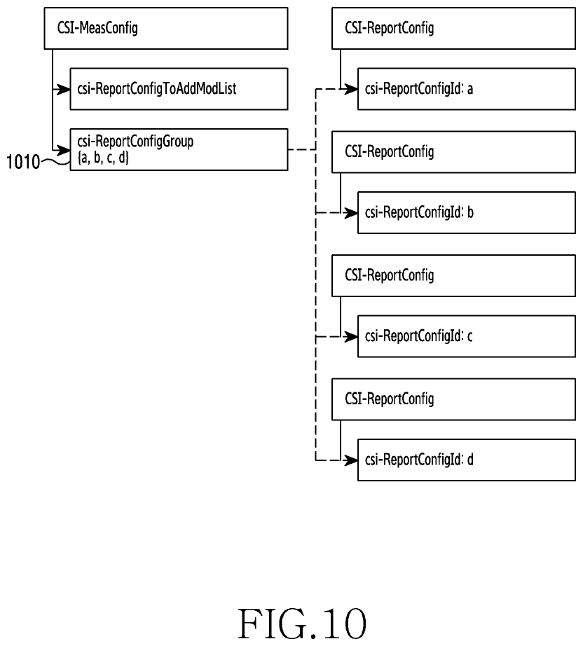

FIG. 10 illustrates configuration information related to SSB measurement reporting by a user equipment according to an embodiment.

Referring to FIG. 10, the RRC configuration information may include information (e.g., csi-ReportConfigGroup) 1010 on a group of configuration information (e.g., CSI-ReportConfig) for measurement result reporting under configuration information (e.g., CSI-MeasConfig) for measurement. The csi-ReportConfigGroup may include identifiers of the grouped CSI-ReportConfigs.

Based on the configuration information illustrated in FIG. 10, the UE may identify CSI-MeasConfig. The UE may identify grouped multiple CSI-ReportConfigs based on csi-ReportConfigGroup (a, b, c, d) 1010 included in the CSI-MeasConfig. For example, if the identifiers included in the csi-ReportConfigGroup 1010 are a, b, c, and d, the UE may identify that each CSI-ReportConfig with an identifier of a, b, c, or d is a grouped CSI-ReportConfig. Therefore, the UE may measure SSB based on the grouped CSI-ReportConfigs and report to the base station for any one of the CSI-ReportConfigs.

The UE may report the measurement result to the base station based on the CSI-ReportConfig that includes the SSB with the best quality of the reference signal received power (RSRP) among multiple CSI-ReportConfigs. For example, when the first CSI-ReportConfig, the second CSI-ReportConfig, the third CSI-ReportConfig, and the fourth CSI-ReportConfig are grouped, if the SSB signal measured based on the first CSI-ReportConfig has the best signal quality, the UE may report only the measurement result for the first CSI-ReportConfig to the base station. The best signal quality may be determined based on a reference signal received power (RSRP), reference signal received quality (RSRQ) and/or signal to interference plus noise ratio (SINR) by the UE.

The UE may measure SSBs for multiple CCs and report the measurement result to the base station according to the configuration (e.g., CSI-ReportConfig) related to the best quality SSB among the measured SSBs.

The UE may report measurement result to the base station based on at least one of the grouped CSI-ReportConfigs. The CSI-ReportConfigs to be reported by the UE to the base station may be selected based on the measurement quality of the SSB and the like.

The names of the parameters shown in FIG. 10 may be applied differently, and parameter identity or similarity may be determined based on the content of the information contained in the parameters and their purpose.

The inclusion or connection relationship between the parameters shown in FIG. 10 is not limited to the content shown in FIG. 10, and embodiments in which the parameters have inclusion or connection relationships different from those in FIG. 10 are not excluded.

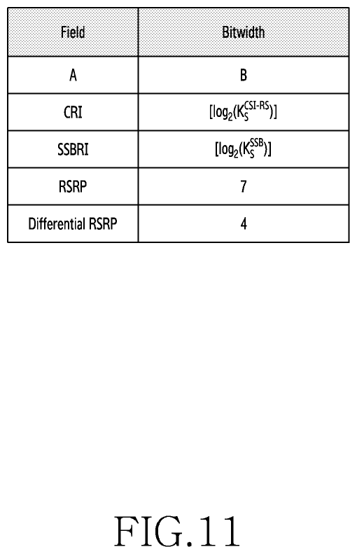

FIG. 11 illustrates information on fields related to SSB measurement reporting by a user equipment according to an embodiment.

The UE may report the SSB measurement result to the base station. The UE may transmit UL control information (UCI) including the SSB measurement result to the base station. The SSB measurement result may be included in the items related to SS/PBCH block resource indicator (SSBRI) or RSRP of the UCI.

Referring to FIG. 11, the measurement result of the UE may include a CSI-RS resource indicator (CRI), an SSBRI, an RSRP, and a differential RSRP. The CRI indicates a CSI-RS resource identifier, and the SSBRI indicates an identifier for identifying an SSB resource. The RSRP may indicate the RSRP value for the SSB with the best signal quality (or the best SSB) among the SSBs measured by the UE, and the differential RSRP may indicate the difference between the RSRP value for the SSB with the best signal quality and the RSRP for other SSBs.

The measurement result of the UE may further include information capable of identifying a CC for the measured best SSB.

The measurement result of the UE may include an identifier for the resource set for which the best SSB is measured. Specifically, the measurement result may include a field value for distinguishing the resource sets configured within the list information (e.g., CSI-SSB-ResourceSetList or nzp-CSI-RS-ResourceSetList) including the resource sets. For example, if the best SSB is SSB 0, the measurement result may include an identifier for the resource set for which SSB 0 is measured. Therefore, the resource set for which the best SSB is measured may be identified, and the CC for which the resource set is measured may be identified via information on the resource set. The information on the resource set may be referenced by the identifier for the resource set, and a CC corresponding to the resource set may be identified. The length of bits allocated to indicate the identifier for the resource set for which the best SSB is measured may correspond to

$${log}_{2} ( {K}_{s}^{RSCSet} ) , where {K}_{s}^{R S CSet}$$

may represent the number of resource sets (ResourceSet) included in the list information (e.g., CSI-SSB-ResourceSetList or nzp-CSI-RS-ResourceSetList) including the resource sets.

The measurement result of the UE may include an identifier (e.g., ServCellIndex) for the CC for which the best SSB is measured. For example, if the best SSB is SSB 0, the measurement result may include an identifier for the CC for which SSB 0 is measured. Therefore, the CC for which the best SSB is measured may be identified. The length of bits allocated to indicate the identifier for the CC for which the best SSB is measured may correspond to

$${log}_{2} ( {K}_{s}^{Cell} ) , where {K}_{s}^{Cell}$$

may represent the maximum number of serving cells (e.g., maxNrofServingCells as defined in TS 38.331) or the maximum number of CCs.

The measurement result of the UE may include an identifier (e.g., csi-ResourceConfigId) for resource configuration information (e.g., CSI-ResourceConfig) related to the best SSB. For example, if the best SSB is SSB 0, the identifier for the resource configuration information related to SSB 0 may be included in the measurement result.

In FIG. 9, the CC for the resource configuration information may be identified via the identifier for the resource configuration information. Therefore, the CC for which the best SSB is measured may be identified. The length of bits allocated to indicate the identifier for the resource configuration information related to the best SSB may correspond to

$${log}_{2} ( {K}_{s}^{RSCConf} ) , where {K}_{s}^{RSCConf}$$

may represent the size (or length) of resourcesForChannelMeasurementList in FIG. 9.

The measurement result of the UE may include an identifier (e.g., csi-ReportConfigId) for report configuration information (e.g., CSI-ReportConfig) related to the best SSB. For example, if the best SSB is SSB 0, the identifier for the report configuration information related to SSB 0 may be included in the measurement result. The CC for the report configuration information may be identified via the identifier for the report configuration information. Therefore, the CC for which the best SSB is measured may be identified. Meanwhile, the length of bits allocated to indicate the identifier for the report configuration information related to the best SSB may correspond to

$${log}_{2} ( {K}_{s}^{RPTConf} ) , where {K}_{s}^{RPTConf}$$

may represent the size (or length) of csi-ReportConfigGroup in FIG. 10.

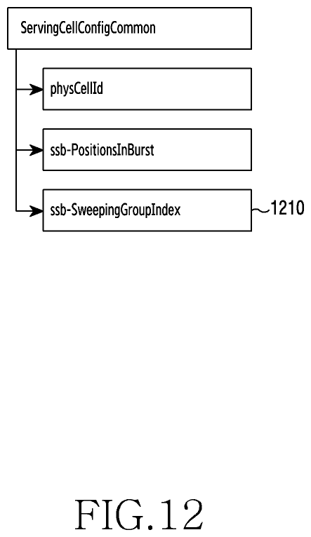

FIG. 12 illustrates configuration information for mapping SSB and RO by a user equipment according to an embodiment.

Referring to FIG. 12, the RRC configuration information may include an index, i.e., ssb-SweepingGroupIndex 1210, for a beam group of the base station under the configuration information (e.g., for a serving ServingCellConfigCommon) cell. The ServingCellConfigCommon may include an identifier (physCellId) of the serving cell, information (ssb-PositionsInBurst) for indicating the location of the SSB, and/or ssb-SweepingGroupIndex 1210 for the beam group. The ServingCellConfigCommon may be information configured for each CC.

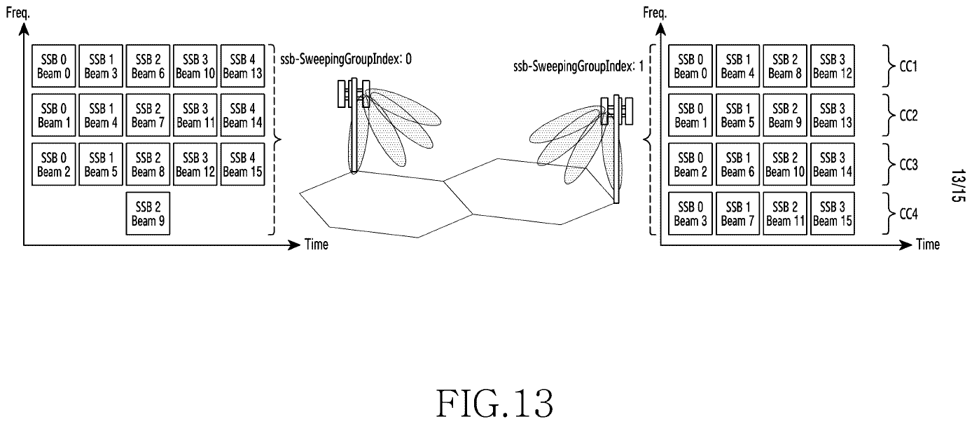

The index for a beam group may indicate the beam group for SSBs indicated by information indicating the location of the SSB. For example, in FIG. 13 described in detail below, the ServingCellConfigCommon for a first CC (e.g., CC1) may include information indicating the locations of SSB 0 (Beam 0), SSB 1 (Beam 4), SSB 2 (Beam 8), and SSB 3 (Beam 12) and a beam group index 1, and the ServingCellConfigCommon for a second CC (e.g., CC2) may include information indicating the locations of SSB 0 (Beam 1), SSB 1 (Beam 5), SSB 2 (Beam 9), and SSB 3 (Beam 13) and the beam group index 1. The ServingCellConfigCommon for a third CC (e.g., CC3) may include information indicating the locations of SSB 0 (Beam 2), SSB 1 (Beam 6), SSB 2 (Beam 10), and SSB 3 (Beam 14) and the beam group index 1, and the ServingCellConfigCommon for a fourth CC (e.g., CC4) may include information indicating the locations of SSB 0 (Beam 3), SSB 1 (Beam 7), SSB 2 (Beam 11), and SSB 3 (Beam 15) and the beam group index 1. That is, since the ServingCellConfigCommons of CC1 to CC4 all include beam group index 1, the UE may identify that the SSBs of CC1 to CC4 all in the same beam group. The UE may perform RO mapping based on the SSB corresponding to the identified beam group. The UE may map ROs for all SSBs having the same beam group in each CC. For example, if SSBs correspond to the same beam group, the UE may map SIB 0 (Beam 1) of the second CC and RO in the first CC.

The UE may map the SSBs of all cells (or CCs) having the same beam group index to the RO.

The UE may receive ssb-SweepingGroupIndex 1210 for a beam group for each CC (or cell) via system a system information block 1 (SIB1).

FIG. 13 illustrates a mapping operation of SSB and RO by a user equipment according to an embodiment.

Referring to FIG. 13, the beam group index may be configured to 1 for cells (e.g., CC1 to CC4) operated by a first base station that transmits SSBs 0 to 3 through beams 0 to 15, and the beam group index may be configured to 0 for cells (e.g., CC1 to CC4) operated by a second base station that transmits SSBs 0 to 4 through beams 0 to 15. In such an environment, for example, if the UE measures SSB and determines that the signal quality of SSB 2 (Beam 9) on CC 2 received from the first base station is the best signal quality, and the UE attempts RACH via another CC, the UE may map SSB 2 (Beam 9) to an RO by referencing configuration information (e.g., ServingCellConfigCommon) for all cells (e.g., CC1 to CC4) that include 1 as the index for the beam group.

The rules for mapping SSB and RO may be based on the priority configured for the UE.

The lower the SSB index in the cell (or CC) in which the UE attempts RACH, the higher the priority. That is, the UE may map the SSB to the RO according to the priority based on the SSB index in the same cell.

The lower the index among cells other than cells in which the UE attempts RACH, the higher the priority. Therefore, the SSB index of the cell having the lowest cell index may be preferentially mapped to the RO from the lowest SSB. That is, the rule for mapping the SSB to the RO by the UE may follow the priority based on the SSB index and/or the cell index.

The index for the beam group may be different between cells operated by the same base station.

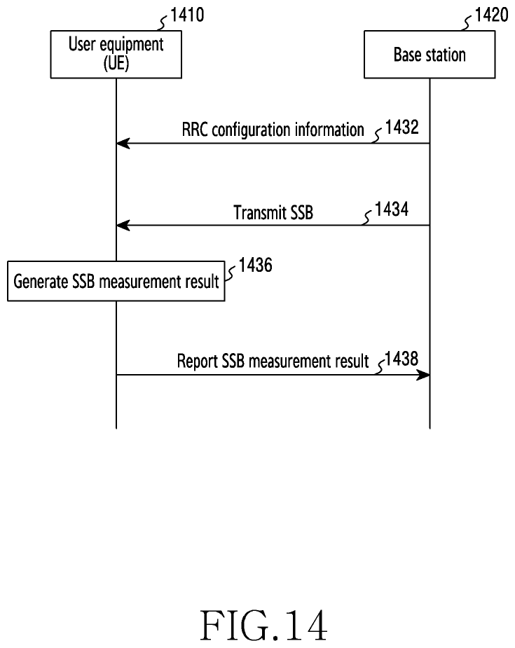

FIG. 14 illustrates transmission and reception operations of a user equipment and a base station according to an embodiment.

Referring to FIG. 14, transmission and reception of configuration information on SSB measurement and reporting between a UE 1410 and a base station 1420 are illustrated.

In step 1432, the UE may receive an RRC message including RRC configuration information from the base station. The RRC message may include an RRC connection setup message, an RRC reconfiguration message, etc. The RRC configuration information included in the RRC message may include the configuration information described in FIGS. 6 to 12. The RRC configuration information may include configuration information for measurement and reporting on SSB.

In step 1434, the UE may receive an SSB from the base station. The base station may transmit the SSB by using different beams for each CC within the same time resource. That is, as described in the second system 420 of FIG. 4 and graphs (b) and (c) of FIG. 5, the base station may transmit the SSB to the UE by using multiple beams. The base station may broadcast the SSB or transmit the same to a specific UE.

In step 1436, the UE may measure the SSB received from the base station and generate a measurement result. Based on the configuration information received in step 1432, the UE may measure the SSB received via different beams in multiple CCs. The UE may measure the first SSB received via the first beam in the first CC and the second SSB received via the second beam in the second CC. The first SSB and the second SSB may be the same or different.

The UE may generate a measurement result based on the configuration information received in step 1432. Based on the configuration information, the UE may identify the CC (or cell) related to the SSB measurement and reporting. For example, for parameters (or fields) included in various layers or linked through mutual reference within configuration information related to the SSB measurement and reporting, the UE may identify which CC the corresponding parameter relates to. Therefore, the UE may measure SSB received via a specific CC and generate a measurement result based on the information indicated by the corresponding parameter. In addition, based on the configuration information, the UE may measure and report SSB for multiple CCs. The SSB measurement result may be based on configuration information related to the SSB having the best signal quality and may include information capable of identifying the CC related to the SSB having the best signal quality.

In step 1438, the UE may transmit a report on the measurement result generated in step 1436 to the base station. The SSB measurement result may include the information described in FIG. 11.

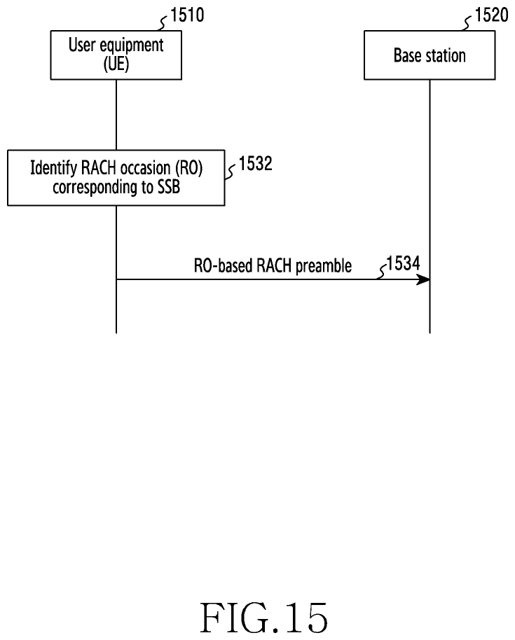

FIG. 15 illustrates a transmission and reception method of a user equipment and a base station according to an embodiment.

Referring to FIG. 15, a method in which a UE 1510 maps the SSB and the RO and transmits the RACH preamble (or message 1) based on the RO is illustrated. The RO may indicate the location of the time resource for transmitting the RACH preamble.

In step 1532, the UE may reference SSBs for multiple CCs to map the SSBs to the RO based on the beam group index for the SSBs of the CC.

In step 1534, when attempting a RACH, the UE may transmit a RACH preamble to the base station based on the mapping result from step 1532.

For example, if the base station transmits SSB0 (Beam 0), SSB1 (Beam 4), SSB2 (Beam 8), and SSB3 (Beam 12) in the first CC and SSB0 (Beam 1), SSB1 (Beam 5), SSB2 (Beam 9), and SSB3 (Beam 13) in the second CC, and if all SSBs for the first and second CCs correspond to the same beam group, the UE may reference the SSBs for the second CC (the first CC) when attempting a RACH in the first CC (or the second CC). Therefore, if the measurement result for SSB0 (Beam 1) is determined to be the best, the UE may transmit a RACH preamble at a time resource location corresponding to the corresponding RO based on the RO mapped to the SSB0 (Beam 1) in the first CC.

The RACH preamble may be referred to as a random access (RA) preamble or message 1, or otherwise as a random access sequence or access initiation signal.

Although embodiments have been described to convey the technical idea of the disclosure in detail, the order of individual operations constituting each embodiment may be changed or some operations may be omitted. Therefore, embodiments in which the order of operations is changed or some operations are omitted from each embodiment may be understood as being described by the disclosure. The embodiments of the disclosure may be modified in various manners based on the contents described herein.

Herein, a singular form of a noun corresponding to an item may include one or more of the items, unless the relevant context clearly indicates otherwise. As used herein, each of such phrases as A or B, at least one of A and B, at least one of A or B, A, B, or C, at least one of A, B, and C, and at least one of A, B, or C, may include all possible combinations of the items enumerated together in a corresponding one of the phrases. Such terms as a first, a second, the first, and the second may be used to simply distinguish a corresponding element from another, and does not limit the elements in other aspect (e.g., importance or order). If an element (e.g., a first element) is referred to, with or without the term operatively or communicatively, as coupled with/to or connected with/to another element (e.g., a second element), this indicates that the element may be coupled/connected with/to the other element directly (e.g., wiredly), wirelessly, or via a third element.

As used herein, the term module may include a unit implemented in hardware, software, or firmware, and may be interchangeably used with other terms, for example, logic, logic block, component, or circuit. The module may be a single integrated component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor 230 of the machine (e.g., an electronic device) may invoke at least one of the one or more instructions stored in the storage medium, and execute it to enable the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term non-transitory indicates that the storage medium is a tangible device, and does not include a signal, but this term does not differentiate between where data is semi-permanently stored in the storage medium and where the data is temporarily stored in the storage medium.

Methods described herein may be included and provided in a computer program product. The computer program product may be traded as a product between a seller and a buyer. The computer program product may be distributed in the form of a CD-ROM, or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each element (e.g., a module or a program) of the above-described elements may include a single entity or multiple entities, and some of the multiple entities may be separately disposed in any other element. One or more of the above-described elements or operations may be omitted, or one or more other elements or operations may be added. Alternatively or additionally, a plurality of elements (e.g., modules or programs) may be integrated into a single element. In such a case, the integrated element may still perform one or more functions of each of the plurality of elements in the same or similar manner as they are performed by a corresponding one of the plurality of elements before the integration. Operations or methods performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving, from a base station, a radio resource control (RRC) message including configuration information for measuring and reporting of synchronization signal blocks (SSBs);
measuring multiple SSBs for multiple component carriers, based on the configuration information; and
transmitting, to the base station, a report on a result of the measuring, based on the configuration information.

2. The method of claim 1,
wherein the configuration information includes first information on a first resource set and second information on a second resource set,
wherein the first information includes a first identifier indicating a first component carrier for the first resource set, and
wherein the second information includes a second identifier indicating a second component carrier for the second resource set.

3. The method of claim 2,
wherein the configuration information further includes third information indicating measurement of at least two resource sets among multiple resource sets including the first resource set and the second resource set.

4. The method of claim 2, wherein the configuration information further includes:
fourth information on a list including identifiers corresponding to multiple resource sets, and
fifth information indicating to measure resource sets corresponding to all the identifiers included in the fourth information.

5. The method of claim 1,
wherein the configuration information includes first information on a first resource set,
wherein the first information includes second information on a list including multiple identifiers corresponding to resources of the first resource set and third information on a list including identifiers corresponding to component carriers for the resources, and
wherein the component carriers for the respective resources of the first resource set are identified based on the second information and the third information.

6. The method of claim 1,
wherein the configuration information includes:
first information on a list including identifiers corresponding to component carriers,
resource configuration information including information on multiple resource sets, and
second information on a list including identifiers corresponding to the resource configuration information, and
wherein the component carriers corresponding to the resource configuration information are identified based on the first information and the second information.

7. The method of claim 1,
wherein the configuration information is indicated by group information indicating a group of pieces of configuration information, and
wherein the report is performed based on configuration information related to an SSB having a best signal quality among multiple pieces of configuration information indicated by the group information.

8. The method of claim 1,
wherein the report includes one of an identifier indicating a resource set related to SSB measurement, an identifier indicating a component carrier related to SSB measurement, an identifier indicating resource configuration information related to SSB measurement, or an identifier indicating configuration information for measurement result reporting.

9. The method of claim 1,
wherein the configuration information includes first information on a serving cell of the UE,
wherein the first information includes an index of a beam group related to the serving cell, and
wherein whether SSBs related to a component carrier of the serving cell and component carriers of other cells correspond to an identical beam group is identified based on the index.

10. The method of claim 9,
wherein a time resource for transmitting a random access preamble by the UE is mapped to one of the SSBs identified as the identical beam group by the index.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, a radio resource control (RRC) message including configuration information for measuring and reporting of synchronization signal blocks (SSBs),
measure multiple SSBs for multiple component carriers, based on the configuration information, and
transmit, to the base station, a report on a result of the measuring, based on the configuration information.

12. The UE of claim 11,
wherein the configuration information includes first information on a first resource set and second information on a second resource set,
wherein the first information includes a first identifier indicating a first component carrier for the first resource set, and
wherein the second information includes a second identifier indicating a second component carrier for the second resource set.

13. The UE of claim 12,
wherein the configuration information further includes third information indicating measurement of at least two resource sets among multiple resource sets including the first resource set and the second resource set.

14. The UE of claim 12,
wherein the configuration information further includes:
fourth information on a list including identifiers corresponding to multiple resource sets, and
fifth information indicating to measure resource sets corresponding to all the identifiers included in the fourth information.

15. The UE of claim 11,
wherein the configuration information includes first information on a first resource set,
wherein the first information includes second information on a list including multiple identifiers corresponding to resources of the first resource set and third information on a list including identifiers corresponding to component carriers for the resources, and
wherein the component carriers for the respective resources of the first resource set are identified based on the second information and the third information.

16. The UE of claim 11, wherein the configuration information includes:
first information on a list including identifiers corresponding to component carriers,
resource configuration information including information on multiple resource sets, and
second information on a list including identifiers corresponding to the resource configuration information, and
wherein the component carriers corresponding to the resource configuration information are identified based on the first information and the second information.

17. The UE of claim 11,
wherein the configuration information is indicated by group information indicating a group of pieces of configuration information, and
wherein the report is performed based on configuration information related to an SSB having a best signal quality among multiple pieces of configuration information indicated by the group information.

18. The UE of claim 11,
wherein the report includes one of an identifier indicating a resource set related to SSB measurement, an identifier indicating a component carrier related to SSB measurement, an identifier indicating resource configuration information related to SSB measurement, or an identifier indicating configuration information for measurement result reporting.

19. The UE of claim 11,
wherein the configuration information includes first information on a serving cell of the user equipment,
wherein the first information includes an index of a beam group related to the serving cell, and
wherein whether SSBs related to a component carrier of the serving cell and component carriers of other cells correspond to an identical beam group is identified based on the index.

20. The UE of claim 19,
wherein a location of a time resource for transmitting a random access preamble by the user equipment is mapped to one of the SSBs identified as the identical beam group by the index.
